(19) United States
(12) Patent Application Publication
(10) Pub. No.: US 2009/0319927 A1
(43) Pub. Date: Dec. 24, 2009

(54) CHECKING DOCUMENT RULES AND PRESENTING CONTEXTUAL RESULTS

(75) Inventors: Anthony Beeman, Shoreline, WA (US); David Morton, Redmond, WA (US); Larry Waldman, Bellevue, WA (US); Ben Wilde, Seattle, WA (US); Marina Dukhon, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/143,770

(22) Filed: Jun. 21, 2008

(51) Int. Cl. G06F 3/048

(52) U.S. Cl. 715/764

(57) ABSTRACT

A document checking system is presented that provides an asynchronous scan of a document for errors and presents a rich user interface to the user that provides information about the error and how to fix it. While the user is accessing the document, the document checking system scans the document to identify one or more violations of a set of rules. The system locates a context within the document for each identified rule violation and determines one or more steps for remedying each rule violation. The system displays a report that includes the identified rule violations along with detailed information about the context of each rule violation and how to fix it.

### BACKGROUND

Users create electronic documents every day. One source estimates that 500 million users use Microsoft Office, one popular suite for creating electronic documents of various types (e.g., spreadsheets, presentations, and so on). Users create documents at every stage of life and in both their business and personal lives. For example, documents may include school reports, financial statements, community newsletters, and many others.

Documents may contain many types of errors. For example, documents may contain typographical errors, incorrect use of grammar, or problems that make the documents unsuitable for a particular purpose of the user. For example, a user may want a document to be broadly readable, but the document may contain elements that, while not incorrect, prevent the document from being consumable by screen reading applications for people who are blind. As another example, the document many contain new elements that older versions of the application in which the user created the document cannot open. For these and many other types of errors, error detection systems exist that automatically search a document for various known types of errors and provide a report to the user.

Many error detection systems present a modal dialog box that prevents the user from interacting with the document while the system scans the document (i.e., synchronous scanning). When the scan is complete, the error detection systems often present the results of the scan in a list within the modal dialog box. It is then up to the user to remember or print all of the issues identified by the scan, close the error detection system, and return to the document to fix the issues. This can be a frustrating experience for the user, particularly when the document is large and the number of issues that need the user's attention is high. One example of this type of error detection system is the compatibility checker that appears in Microsoft Word 2007 when a user attempts to save a Word 2007 DOCX file to a Word 2003 DOC file. Because the DOCX format provides features that cannot be expressed in the DOC format, the compatibility checker warns the user about information that will be lost by saving a document in the older format. The compatibility checker presents a detailed, synchronous result summary that the user can review and then dismiss. After the user has closed the result summary, the user can interact with the document and make any desired changes.

Other error detection systems perform scans non-modally (i.e., asynchronous scanning), but only provide basic information. These error detection systems generally assume that because the user could be doing any number of things with the document while the scan is being performed, it is not appropriate for the error detection system to present extensive user interface elements that could interfere with what the user is doing. One example of this type of error detection system is the background spell checker in Microsoft Word 2007. The background spell checker operates periodically even when the user is modifying the document. However, the background spell checker only presents basic scan results (e.g., red squiggly lines under misspelled words). To get more information to fix the errors, the user has to open a different user interface, such as the Spelling and Grammar dialog or the Spelling context menu.

An additional problem with current error detection systems is that many systems expect the user to manually update the scan results. For example, many systems require a user to invoke a scan of the document, and click a rescan button whenever the user wants to see new results. In such systems, as the user edits the document the results become out of synch with the document. For example, the user may add new paragraphs to the document with new errors that are not identified in the report. The user may also modify or remove existing paragraphs that contained errors, causing the report to display errors that no longer exist. Because it is up to the user to invoke the scan, the user may forget to run the scan and send the document to someone else without detecting important errors.

### SUMMARY

A document checking system is presented that provides an asynchronous scan of a document for errors and presents a rich user interface to the user that provides information about the error and how to fix it. While the user is accessing the document, the document checking system scans the document to identify one or more violations of a set of rules (i.e., errors). The system locates a context within the document for each identified rule violation. The system also determines one or more steps for remedying each rule violation. The system displays to the user a report that includes the identified rule violations. The system receives from the user a selection of a rule violation displayed in the report. For the selected rule violation, the system displays both a portion of the document associated with the selected rule violation based on the located context, and the determined steps for remedying the rule violation so that the user can use access the steps and the portion of the document associated with the rule violation simultaneously. Thus, the document checking system presents rich scan results while the user is interacting with the document and in context to the user, such that the user can use the results to navigate to and fix errors highlighted by the scan results.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates components of a document checking system, in one embodiment.

FIG. 2 is a flow diagram that illustrates the processing of the document checking system to continuously scan a document, in one embodiment.

FIG. 3 illustrates a display page of a user interface of the document checking system, in one embodiment.

FIG. 4 is a display page that illustrates an accessibility checker display area in further detail.

### DETAILED DESCRIPTION

A document checking system is presented that provides an asynchronous scan of a document for errors and presents a rich user interface to the user that provides information about the error and how to fix it. Many types of document errors benefit from extended information about the error and how to fix it that is presented in a way that the user can go directly to the error and fix it. While the user is accessing the document, the document checking system scans the document to identify one or more violations of a set of rules (i.e., errors). For example, the system may identify tables within the document that have merged cells. The system locates a context within the document for each identified rule violation. For example, if the error occurs in a table then the system may identify the page within the document where the table is located and the cells within the table that violate the rule. The system also determines one or more steps for remedying each rule violation. For example, the system may determine that an appropriate way to fix the rule violation is to unmerge or split the cells.

The system displays to the user a report that includes the identified rule violations. For example, the system may display a task pane in a window adjacent to the document so that the user can view detailed information about the rule violations in the document and can view the document at the same time. The system receives from the user a selection of a rule violation displayed in the report. For example, the user may select the first rule violation. For the selected rule violation, the system displays both a portion of the document associated with the selected rule violation based on the located context, and the determined steps for remedying the rule violation so that the user can use access the steps and the portion of the document associated with the rule violation simultaneously. When the user fixes the rule violation, the system removes the violation from the scan results automatically. Thus, the document checking system presents rich scan results while the user is interacting with the document and in context to the user, such that the user can use the results to navigate to and fix errors highlighted by the scan results. The document checking system also routinely updates the information so that the results are up to date without depending on the user to rescan the document when the user modifies the document.

One example of the document checking system is an accessibility checker. The accessibility checker scans a document for errors that make the document harder to read or modify by those with disabilities. For example, the accessibility checker may identify images within a document that do not have alternate text for a screen reader to read, merged table cells that make it difficult for accessibility tools to convey the structure of a table, tables that lack a table header to describe the contents of each column, and so forth.

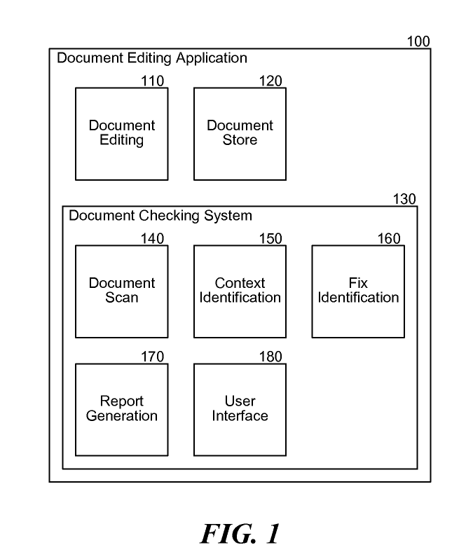

FIG. 1 is a block diagram that illustrates the components of the document checking system, in one embodiment. The document checking system 130 may be part of a document editing application 100 as shown, or may be a separate component that interacts with a document editing application 100 (such as through an object model or Application Programming Interface (API) of the document editing application 100). The document editing application includes a document editing component 110 that provides various ways of modifying and displaying the document, and a document store 120 for persisting the document (e.g., to a disk drive) between editing sessions. The document checking system 130 includes a document scan component 140, a context identification component 150, a fix identification component 160, a report generation component 170, and a user interface component 180. Each of these components is described in further detail in the following paragraphs.

The document scan component 140 scans the document for errors in real time as the user edits the document. The document scan component 140 applies a set of rules to determine whether each element in the document violates any of the rules or contains errors. For example, one rule may specify that tables should have a header row. If the document scan component 140 identifies a table within the document that is missing a header row, then the document scan component 140 records an error for reporting to the user. The rules may be stored in a file or other storage medium accessible by the document scan component 140. As the user makes changes, the document scan component 140 rescans all or part of the document to determine whether the changes result in new errors. Thus, the document scan component 140 keeps the results report in synch with the document, as described further below.

The context identification component 150 identifies the context of each error, so that each error is associated with where it occurs in the document. For a word processor, the context identification component 150 may identify a page and item or document element on the page. For a spreadsheet, the context identification component 150 may identify a cell or range of cells within the spreadsheet. For a presentation, the context identification component 150 may identify a slide and an element on the slide.

The fix identification component 160 identifies an appropriate fix for each error and associates the fix with the error. For example, if the error indicates that an image in the document is missing alternate text that is useful for users without sight that are reading the document using a screen reader, then the fix identification component 160 retrieves information about adding alternate text to the image. The fix identification component 160 may identify both why the error should be fixed as well as how to fix the error. In some embodiments, the fix identification component identifies specific functionality that will fix the problem, such as a user interface for fixing the error, and provides the functionality to the user. The fix for each error may be static and stored in association with the set of rules or may be dynamically determined based on the error itself. For example, the fix identification component 160 may dynamically suggest a table heading for a column of data missing a header row based on the contents of the column.

The report generation component 170 generates a report based on the errors identified by the document scan component 140. The report includes an identification of the error (e.g., the type of error, the name of the document element containing the error, and so on), the context in the document where the error occurs, and the fix proposed for remedying the error. For example, the report may indicate that a document element “Picture 1” is missing alternate text, that the lack of alternate text makes the document harder to read by users reading the document through a screen reader, and that an appropriate way of fixing the error is to add alternate text to the image.

The user interface component 180 displays the generated report to the user and allows the user to make modifications to the document to fix the displayed errors. In some embodiments, the user interface component 180 presents a results window docked to the document editing application (sometimes called a task pane) so that the user can see the document and the results window at the same time. From the results window, the user can select a particular error and the context identification component 150 causes the document editing application to display the location within the document where the error occurs. For example, the document editing application may scroll to a particular page and highlight a particular passage of text. At the same time, the task pane may display information about how to fix the error provided by the fix identification component 160.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

As described above the document scan component scans the document periodically for errors in the document. In some embodiments, the document checking system rechecks the document upon the occurrence of a certain event. For example, the system may set a timer and scan the document whenever the timer expires, or the system may wait for a certain period of idle time where the user is not typing or interacting with the document in another manner (e.g., clicking, using a digital pen). The system may also avoid rescanning the document until detecting a change in the document.

When the system delays scanning the document, such as in the ways described above, it is possible for an error to be listed in the results report that is no longer found in the document. In some embodiments, when a user selects an error in the user interface, the document checking system first checks whether that error is still found in the document (such as by using the context information to rescan the portion of the document associated with the error). If the error is no longer found in the document, then the system removes the error from the report. The system may or may not display information that the error has been corrected to the user. For example, the user may not need additional information because the user is likely to notice that the error was removed from the list and that clicking on the error did not navigate the user to a location within the document. In some embodiments, the scan runs fast enough that the rules violation will appear and disappear in a seemingly live manner as the user edits the document.

In some embodiments, the document checking system only scans changed portions of the document. For example, if a user inserts a new paragraph, then the document checking system may scan only the new paragraph and add the results to the previous results for the rest of the document. In this way, the document checking system can operate more efficiently.

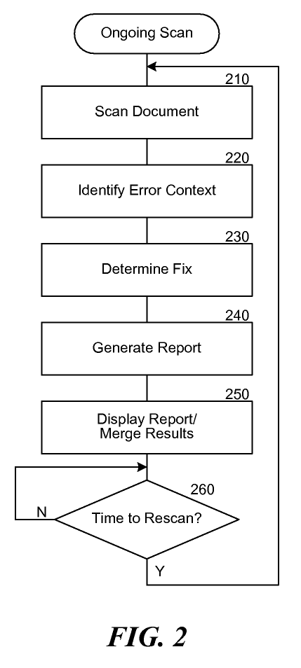

FIG. 2 is a flow diagram that illustrates the processing of the document checking system to continuously scan the document, in one embodiment. The continuous scan is invoked whenever the document is open for editing or may be initiated when the user requests the task pane associated with the document checking system. In block 210, the system scans the document to identify any violations of the set of rules (i.e., errors). For example, the system may search the document for document elements that could violate each rule and test the document elements against the rule. As an example, if the rule indicates that tables should have a header row then the system searches the document for tables and then tests whether the tables contain a header row. In block 220, the system identifies the context of the error. For example, the system may store the location where the error occurred in association with an error record held in memory.

In block 230, the system determines an appropriate manner of fixing the error. For example, the system may access a corresponding fix associated with each rule and associate the fix with the error record. In block 240, the system generates a report that includes a list of identified rule violations, the context where the error occurs in the document, and the appropriate fix. In block 250, the system displays the report to the user. Because the report and scan may be continuously occurring, the system may already be displaying a previous report. In such cases, the system merges the new report with the old report and updates the display, such as by adding newly identified errors and removing corrected errors. In some embodiments, the context and appropriate fix associated with the report are not displayed until the user clicks on a particular rule violation. At that point, the system may navigate to the identified context within the document and display the information about how to remedy the rule violation.

In decision block 260, the system determines whether it is time to rescan the document and, if so, loops to block 210 to rescan the document, else the system waits until the appropriate time to rescan the document. As discussed above, the system may determine when to rescan the document based on detecting when the user modifies the document, by waiting for idle application time, based on a time, and so forth. The system exits the loop of FIG. 2 when the user closes the document or the task pane associated with the document checking system.

In some embodiments, the document checking system interacts with applications having multiple open documents at a time. The document checking system may maintain up to date scans of all of the documents, or may scan each document as the user brings it to the foreground. Likewise, the displayed report may only reflect the document that is in the foreground.

The set of rules and the types of errors used by the document checking system vary based on the purpose for which the document checking system is used. In some embodiments, the set of rules is extensible such that the user can install additional rules over time. For example, certain rules may be appropriate for different countries or cultures and may be provided in a language pack add-on to the system. Alternatively or additionally, the rules may be organized by purpose so that the user can perform a document scan for different purposes by selecting a different set of rules. The following table describes some of the types of errors included in the set of rules used by the document checking system for three popular document editing applications in the context of accessibility for people with disabilities.

| Application(s) | Severity | Error | Description |
|---|---|---|---|
| Microsoft Word, | Error | Image Without Alt | Images that are missing |
| Microsoft Excel, | | Text | alternate text provide no |
| Microsoft PowerPoint | | | information to users with |
| | | | screen readers. |
| Microsoft Word, | Error | Table Without | Tables that do not have |
| Microsoft Excel, | | Header | headers describing the |
| Microsoft PowerPoint | | | content of each column can |
| | | | make navigation confusing to |
| | | | users with screen readers. |
| Microsoft Word, | Error | Information Rights | Documents with restrictive |
| Microsoft Excel, | | Management (IRM) | IRM policies may not allow |
| Microsoft PowerPoint | | Access | screen readers to access |
| | | | parts of the document. |
| Microsoft Word | Error | Document Structure | Long word processing |
| | | Error | documents that do not use |
| | | | built-in heading styles can be |
| | | | difficult to navigate. |
| Microsoft PowerPoint | Error | No Slide Title | Presentation slides without |
| | | | titles do not provide enough |
| | | | context to introduce the |
| | | | information on the slide to |
| | | | some users. |
| Microsoft Word | Warning | Heading Spacing | If heading text is spaced too |
| | | | far apart, some users may |
| | | | have difficulty navigating the |
| | | | document. |
| Microsoft Word, | Warning | Blank Table Cells | Blank table cells can be |
| Microsoft Excel, | | | confusing when navigating a |
| Microsoft PowerPoint | | | table because the table's |
| | | | structure can be unclear.. |
| Microsoft Word, | Warning | 2D Tables Structure | Some tables with merged or |
| Microsoft PowerPoint | | | split cells can be difficult to |
| | | | navigate and understand. |
| Microsoft Word, | Warning | Meaningful Link | Hyperlink text should contain |
| Microsoft Excel, | | Text | enough information to convey |
| Microsoft PowerPoint | | | the content linked to. |
| Microsoft Word | Warning | Heading Length | Long headings can make |
| | | | navigation of some documents |
| | | | difficult by not providing |
| | | | enough of an overview of the |
| | | | content to follow. |
| Microsoft Word | Warning | Floating Objects | Objects without a location |
| | | | relative to other objects are |
| | | | sometimes not read by screen |
| | | | readers. |
| Microsoft Word | Warning | Repeated | Repeated whitespace can |
| | | Whitespace | cause long, redundant |
| | | | descriptions within a screen |
| | | | reader. |
| Microsoft Excel | Warning | Meaningful Sheet | Sheet names should describe |
| | | Names | the data each sheet contains |
| | | | for quick navigation (e.g., not |
| | | | Sheet1, Sheet2, and so on). |
| Microsoft Word | Tip | Layout Table | Tables that are used for |
| | | Reading Order | spacing and formatting can be |
| | | | confusing if the elements in |
| | | | that table are not organized |
| | | | appropriately. |
| Microsoft Word | Tip | Image Watermarks | Watermarks that are images |
| | | | can be difficult for people with |
| | | | visual impairments to see. |
| Microsoft Word | Tip | Heading Ordering | If heading styles are skipped |
| | | | (such that heading style 1 is |
| | | | never followed immediately by |
| | | | heading style 3), the |
| | | | document can be difficult for |
| | | | some people to navigate |
| Microsoft PowerPoint | Tip | Captions | If an audio or video clip does |
| | | | not have closed captions, it |
| | | | can be difficult for people who |
| | | | are hard of hearing to |
| | | | understand. |
| Microsoft PowerPoint | Tip | Slide Reading Order | If the objects on a |
| | | | presentation slide are |
| | | | arranged visually, the meaning |
| | | | of the slide can be difficult for |
| | | | people who can not see it to |
| | | | understand. |
| Microsoft PowerPoint | Tip | Unique Titles | Slides without unique titles are |
| | | | difficult to distinguish. |

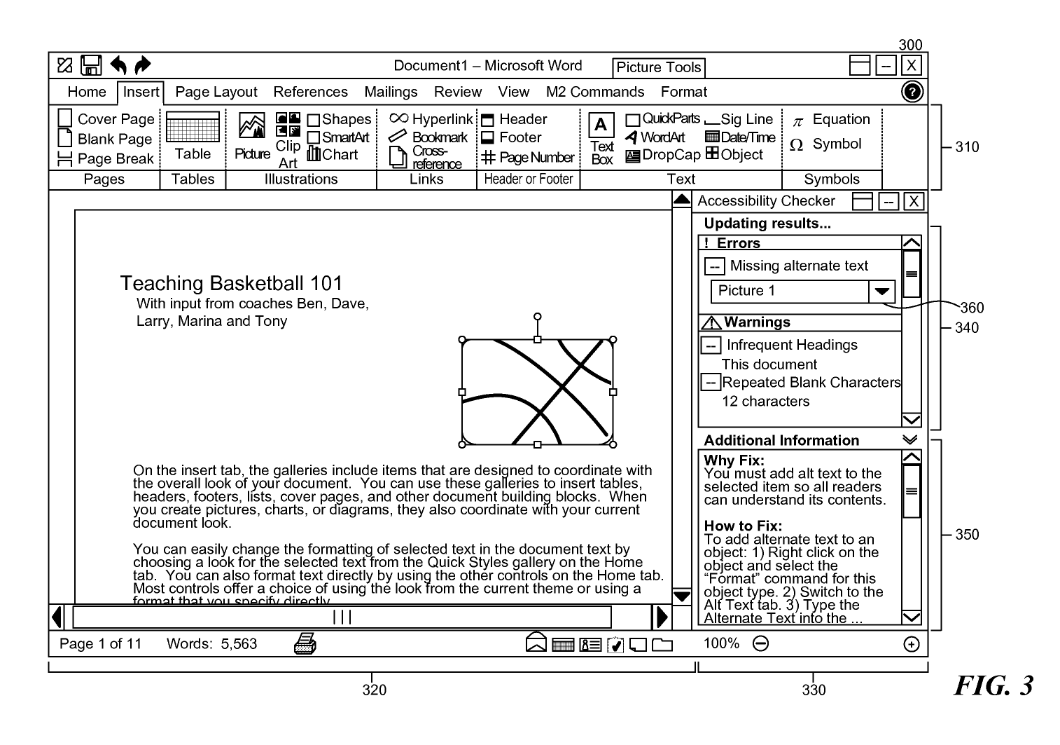

FIG. 3 illustrates a display page of the user interface of the document checking system, in one embodiment. The display page 300 includes editing controls 310, a document display area 320, and an accessibility checker display area 330 (e.g., a task pane). The accessibility checker display area 330 includes an error list 340 and an information display area 350. The error list 340 lists the errors, categorized by severity and type of error, found during the scan of the document. The user has selected an error 360 from the list for an image missing alternate text, which updated the document display area 320 to highlight the image 370 that contains the error. The information display area 350 describes to the user why the error should be fixed and how to fix the error. For the illustrated error, the user can fix the error by opening the image's properties and providing the alternate text, or the user can type the alternate text inline into the selected error 360. The system may provide several ways of fixing errors, including by displaying a user interface directly from within the information display area 350.

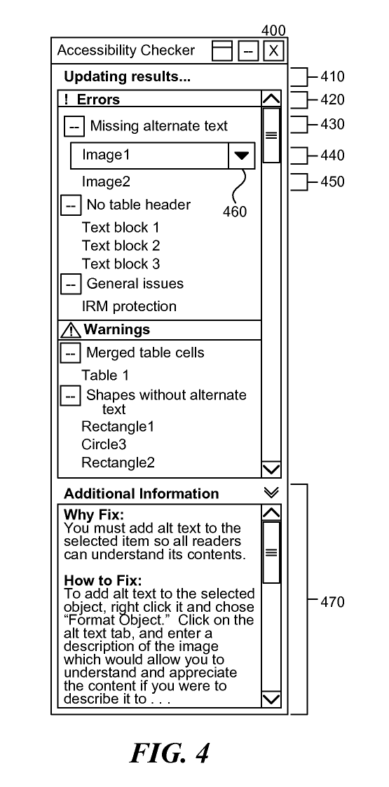

FIG. 4 is a display page that illustrates the accessibility checker display area 330 of FIG. 3 in further detail. The page 400 contains a status bar 410, one or more severity headings 420, one or more error groups 430, individual errors 440 and 450, and corrective information 470. The status bar 410 displays the status of the asynchronous scan of the document. For example, in FIG. 4 the status is “updating results” indicating that the system is continuing to scan updated portions of the document and the display page 400 is being updated with the results. The user may see rule violations dynamically added and removed from the display page 400 as the user modifies the document and the scan repeats. The rule violations identified by the scan are grouped first by severity as indicated by the severity headings 420. More important rule violations are classified as “errors” while less important rule violations are classified as “warnings.” The document checking system may also display a third category called “tips” or even further categories. Within each of the severity headings 420, the document checking system displays a list of error groups 430. Each error of the same type belongs to the same group and the system only displays a short description of the error once. Beneath each of the error groups 430, the system lists individual errors, such as 440 and 450. When the user selects an error 440, the corrective information 470 updates to display why and how the selected error should be fixed. The error 440 may also have a control 460 for getting more information or directly correcting the error 440.

In some embodiments, the document checking system limits the number of rule violations displayed to the user. For example, the system may only display a predetermined number of rule violations (e.g., the first 1,000 violations). As another example, the system may only display a certain number of each type of rule violation (e.g., max 5 of each type). As the user fixes the displayed rule violations, the system may display the additional rule violations to the user. The system may also determine the number of rules to display dynamically, such as based on the available computing resources of the computer on which the system is running and the expected performance of the system.

In some embodiments, the document checking system is invoked when a user prepares the document for distribution. For example, the system may receive an indication that the user is ready to distribute the document. For example, the user may click a button to email the document to a colleague. Upon receiving the indication, the system scans the document to identify content of the document that is difficult to consume for some users. For example, as described above, the system may scan the document to identify violations of accessibility rules. Then, the system guides the user through the document to make the document more accessible. For example, the system may display a portion of the document containing the identified content that is difficult to consume. The system may also display information describing why the identified content is difficult to consume for some users. For example, the information may not be comprehensible to a screen reader that reads written or electronic information to a blind person. In addition, the system may display information describing how to make the identified content easier to consume. For example, the system may suggest ways to reformat or modify the document as described further herein. Thus, the document checking system helps the user to distribute documents that are accessible by more users.

In some embodiments, an administrator may determine the types of rule violations for which a user receives notification and whether the user must fix the violations before distributing the document. For example, an administrator can configure whether a particular rule is classified as an error or warning or whether violations of the rule are reported to the user at all. Some rules may be more relevant in certain contexts than others may. In addition, the administrator may be able to control whether a user can ignore reported violations and distribute a document anyway or whether the user is blocked from distributing the document until the errors are fixed. This allows the administrator to control the accessibility of documents being distributed from the administrator's organization.

In some embodiments, the document checking system provides an object model or API for controlling and extending the system. For example, the administrator discussed previously can use the object model to programmatically run a scan on documents within an organization. As another example, the administrator may be able to intercept the user's interaction with the user interface to implement the distribution restrictions described in the previous paragraph. For example, the administrator could intercept clicks of the send button in an email application and not allow sending documents until scans of the documents do not produce rule violations.

From the foregoing, it will be appreciated that specific embodiments of the document checking system have been described herein for purposes of illustration, but that various modifications may be made without deviating from the spirit and scope of the invention. For example, although document scans based on accessibility rules have been described, those of ordinary skill in the art will appreciate that the techniques described can be applied to many types of document scanning, such as scans for consistent style usage, compatibility issues, spreadsheet formula errors, and so forth. In addition, many types of documents can benefit from the techniques described, including Internet formats such as HTML, XML, and so forth. Accordingly, the invention is not limited except as by the appended claims.

I/We claim:

1. A method of scanning a document for violations of a set of rules while a user is accessing the document and reporting results interactively, the method comprising:
while a user is accessing the document, scanning the document to identify one or more violations of the set of rules;
locating a context within the document of each identified rule violation;
determining one or more steps for remedying each rule violation;
displaying to the user a report that includes the identified rule violations;
receiving from the user a selection of a rule violation displayed in the report;
displaying: (1) a portion of the document associated with the selected rule violation based on the located context, and (2) the determined steps for remedying the rule violation so that the user can use access the steps and the portion of the document associated with the rule violation simultaneously.

2. The method of claim 1 further comprising receiving from the user a modification of the document and automatically rescanning at least some of the document to identify additional violations.

3. The method of claim 2 wherein rescanning at least some of the document comprises focusing the rescanning on a portion of the document modified by the user.

4. The method of claim 1 further comprising receiving from the user a modification of the document and rescanning at least some of the document to determine whether any identified rule violations have been corrected.

5. The method of claim 1 wherein the set of rules comprises rules for identifying portions of a document that are difficult to access by a person with a disability.

6. The method of claim 1 wherein displaying a report comprises displaying a window on a display associated with a window displaying the document.

7. The method of claim 1 further comprising scanning the document periodically and updating the displayed report based on any changes in the rule violations identified by scanning the document.

8. The method of claim 1 wherein the displayed report identifies a relative severity of the identified rule violations.

9. The method of claim 1 further comprising, after receiving from the user a selection of a rule violation, determining whether the rule violation still exists in the document and, when the rule violation no longer exists in the document, removing the rule violation from the displayed report.

10. A computer system for asynchronously searching a document for errors and displaying the errors contextually to a user, the system comprising:
a document scan component configured to asynchronously search the document and identify one or more errors;
a context identification component configured to identify a context of each identified error, wherein the context identifies an element within the document associated with the error;
a report generation component configured to generate a report that identifies each error and the element within the document associated with each error;
a user interface component configured to display the document and the generated report at the same time.

11. The system of claim 10 wherein the user interface component is further configured to receive a selection of an identified error in the displayed report and navigate the display of the document to the element associated with the error.

12. The system of claim 10 wherein the document scan component if further configured to classify each identified error based on a severity of the error.

13. The system of claim 10 further comprising an object model component configured to allow an administrator to programmatically run a scan on documents within an organization.

14. The system of claim 10 further comprising a fix identification component configured to identify a manner of fixing each identified error.

15. The system of claim 14 wherein the user interface component is further configured to receive a selection of an identified error in the displayed report and display the identified manner of fixing the identified error.

16. The system of claim 10 wherein the user interface component is further configured to: (1) receive input from the user to fix an identified error inline within the displayed generated report and (2) modify the document based on the received input.

17. A computer-readable medium containing instructions for controlling a computer system to prepare a document for distribution, by a method comprising:
receiving an indication that a user is ready to distribute the document;
scanning the document to identify content of the document that is difficult to consume for some users;
guiding the user through the document to make the document more accessible, by:
displaying a portion of the document containing the identified content;
displaying information describing why the identified content is difficult to consume for some users; and
displaying information describing how to make the identified content easier to consume.

18. The computer-readable medium of claim 17 further comprising receiving from the user a modification to the document that makes the identified content easier to consume.

19. The computer-readable medium of claim 17 wherein displaying a portion of the document comprises navigating within the document and highlighting one or more elements of the document.

20. The computer-readable medium of claim 17 further comprising preventing the user from distributing the document until the user has modified the content that is difficult for some users to consume.
